(19) United States
(12) Patent Application Publication
(10) Pub. No.: US 2016/0273419 A1
(43) Pub. Date: Sep. 22, 2016

(54) SELF-LUBRICATING SEALED VALVE GUIDE

(71) Applicant: Electro-Motive Diesel, Inc., LaGrange, IL (US)

(72) Inventor: Robert Thurber MacVicar, Downers Grove, IL (US)

(73) Assignee: Electro-Motive Diesel, Inc., LaGrange, IL (US)

(21) Appl. No.: 14/663,025

(22) Filed: Mar. 19, 2015

(51) Int. Cl. F01L 3/08; F16K 1/32

(52) U.S. Cl. CPC F01L 3/08; F16K 1/32

(57) ABSTRACT

A valve system is disclosed, which may comprise a valve including a stem, the stem being oriented along a valve axis. Further, a valve guide may be disposed around the valve and may be oriented along the valve axis, and a bearing material may be employed between the stem and the valve guide along less than a full length of the valve guide.

### TECHNICAL FIELD

The present disclosure generally relates to internal combustion engines, and more particularly, relates to the lubrication of valves in an internal combustion engine.

### BACKGROUND

Internal combustion engines are commonly used in a variety of applications, including vehicles, power generation or industrial settings, to convert chemical fuel energy into mechanical and heat energy. Such vehicles may include railroad locomotives, earth-moving machines and the like. Diesel fuel, gasoline or other fuels can be burned during operation.

An internal combustion engine may employ one or more valves arranged to selectively allow a gas or fluid to pass through. Such a valve may be an intake valve that allows air, fuel or both to pass. The valve may also be an exhaust valve that allows exhaust gasses to exit the engine. These valves may be actuated, directly or indirectly, by a radially-asymmetric cam lobe or by electromechanical means.

In operation, such a valve may open and close rapidly, as the engine runs and the cam lobe rotates. When opening and closing, the valve travels generally along an axis and within a valve guide. Valve parts and valve guide parts may thus be in close proximity, or contact, and in relative motion. To decrease part wear, lubrication is generally used at this interface. Fluid lubricants, such as oils, can enter an end of the valve guide and provide lubrication. However, this method may result in excessive oil consumption and emissions as the oil travels into the combustion chamber, or is burned by high exhaust temperatures.

Alternatively, a self-lubricating material can provide the desired lubrication. U.S. Pat. No. 5,406,917 discloses an ‘Oil-Starved Valve Assembly. The patent describes how a “ . . . valve stem guide is provided with an internal bore having a solid film of lubricant impregnated therewithin.” However, a solid film of lubricant distributed over the full length of the internal bore, as taught, may prove prohibitively expensive. These costs may be especially severe in larger engines with larger components.

Accordingly, there is a need for an improved lubrication system for internal combustion engine valves.

### SUMMARY OF THE DISCLOSURE

In one aspect, an valve system is disclosed. The valve system may include a valve with a stem, the stem being oriented along a valve axis, and a valve guide disposed around the valve and oriented along the valve axis, wherein a bearing material is employed between the stem and the valve guide along less than a full length of the valve guide.

In another aspect, an internal combustion engine is disclosed. The internal combustion engine may include an engine block, a cylinder provided in the engine block, a valve system including a valve operatively associated with the cylinder, the valve including a stem, the stem being oriented along a valve axis, and a valve guide disposed around the valve and oriented along the valve axis, wherein a bearing material is employed between the stem and the valve guide along less than a full length of the valve guide.

In another aspect, a method of reducing friction between a valve and valve guide is disclosed. The method may include providing a valve with a stem, the stem being oriented along a valve axis, positioning a valve guide around the valve and orienting the valve guide along the valve axis, and employing a self-lubricating bearing material between the stem and the valve guide along less than a full length of the valve guide.

These, and other aspects and features of the present disclosure, will be better understood upon reading the following detailed description when taken in conjunction with the accompanying drawings.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a perspective view of an internal combustion engine in accordance with the present disclosure.

FIG. 2 is a sectional view of valve guide in accordance with the present disclosure.

FIG. 3 is a perspective view of a bushing in accordance with the present disclosure.

FIG. 4 is a sectional view of a valve guide in accordance with the present disclosure.

FIG. 5 is a sectional view of another embodiment of the valve guide of FIG. 5.

FIG. 6 is a sectional view of still another embodiment of the valve guide of FIG. 5.

FIG. 7 is a flowchart depicting a sample sequence of actions which may be practiced in an embodiment of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

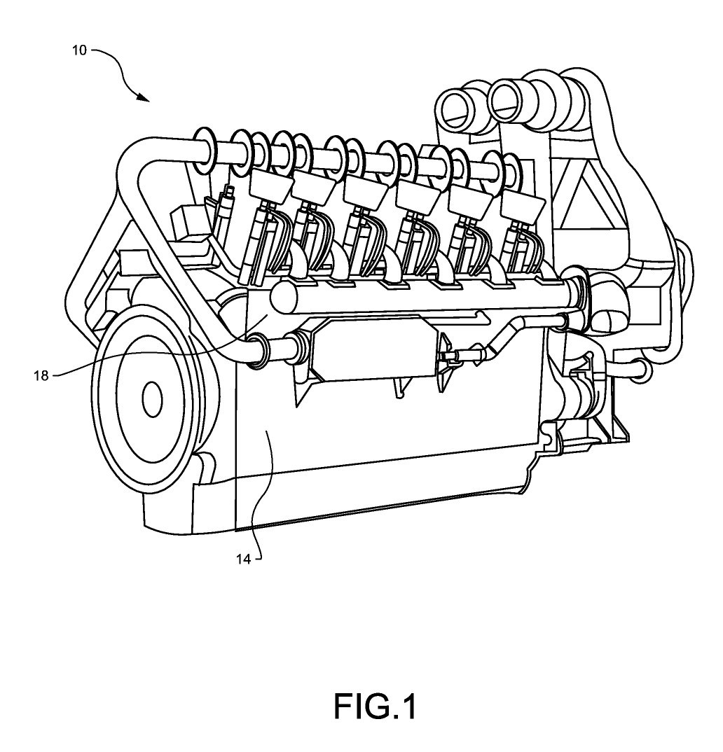

Referring now to the drawings, and with specific reference to FIG. 1, an internal combustion engine constructed in accordance with the present disclosure is generally referred to by reference numeral 10. The internal combustion engine 10 may include an engine block 14 having one or more cylinders 18. The internal combustion engine 10 may function by drawing intake air into the cylinders 18, mixing the air with a fuel, compressing the mixed air and fuel, igniting the mixture, and expelling exhaust gases. In the process, the reciprocating motion of certain internal combustion engine 10 components can be converted into rotational motion for useful work. This useful work can, for example, be used to power locomotives, earth-moving vehicles, other vehicles or industrial processes. The internal combustion engine 10 may be a spark-ignition engine or a compression-ignition engine, and may be designed to use gasoline, diesel fuel, natural gas or other fuels.

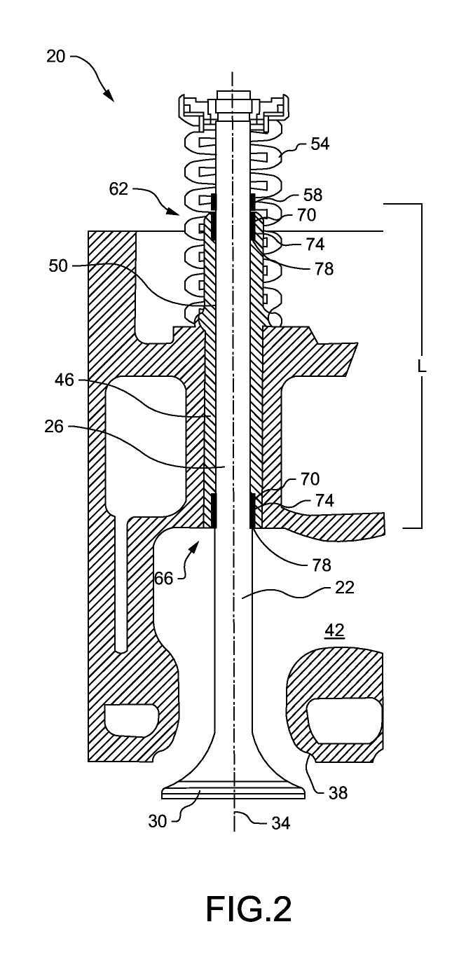

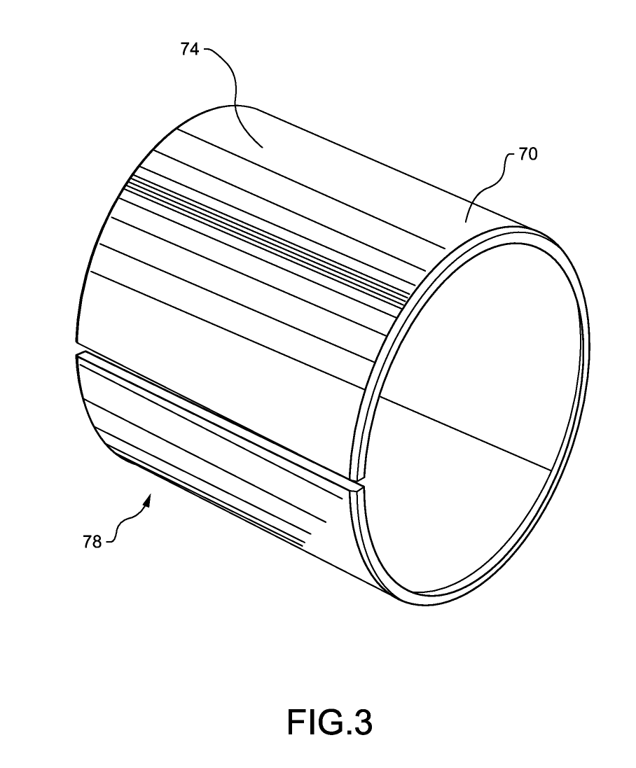

The internal combustion engine 10 may include a valve system 20 with one or more valves 22, as shown in FIG. 2. The valve 22 may be used to selectively allow a gas or fluid to pass. Such a valve 22 may be an intake valve that allows air, fuel or both to pass into the cylinder 18. The valve 22 may also be an exhaust valve that allows exhaust gasses to exit the cylinder 18.

The valve 22 may include a stem 26 and valve head 30, and may be oriented along a valve axis 34. The valve head 30 may prevent gas passage at a valve seat 38 when the valve 22 is closed. When the valve 22 is open, gasses may pass between a port 42 and the cylinder 18 on the intake side, or between the cylinder 18 and the port 42 on the exhaust side.

In internal combustion engine 10 operation, the valve 22 may open and close rapidly. As is commonly known in the art, the valve 22 may be actuated by any number of system including, but not limited to, cam lobes, rockers, hydraulic or electromechanical means. When opening and closing, the valve 22 travels generally along the valve axis 34 and within a valve guide 46. The valve guide 46, which may be disposed around the valve 22, may serve to position and contain the valve 22 during operation. The valve guide 46 may also be oriented along the valve axis 34, and may include an inner bore 50. Further, a length L may define the full length of the valve guide.

A spring 54 may bias the valve 22 in a particular direction, such that when the valve 22 is moved, the spring 54 acts on the valve in a particular direction. In one embodiment, the valve 22 may be biased towards a closed position by the spring 54. Further, a seal 58 may be included at an end of the valve guide 46. The seal 58 may be a zero-leakage seal, which permits no fluid passage into the valve guide 46 from an interior engine space 60. The interior engine space 60 may a crankcase, rocker housing or the like. In operation, the seal 58 may be fixed relative to the valve guide 46, while the valve 22 may be movable relative to the seal 58.

In addition to biasing the valve 22 between open and closed positions, or along the valve axis 34, the spring 54 may bias the valve 22 at an angle relative to the valve axis 34. This valve 22 movement may be known as valve cocking, and may result from asymmetric spring 54 forces or other component interactions. As the valve 22 experiences valve cocking, the valve 22 may only contact the valve guide 46 or inner bore 50 at a first end 62, a second end 66 or at both first and second ends 62, 66. Accordingly, other portions of the valve guide 46 or inner bore 50 away from the first or second ends 62, 66 may not experience a large degree of, or any, contact with the valve 22.

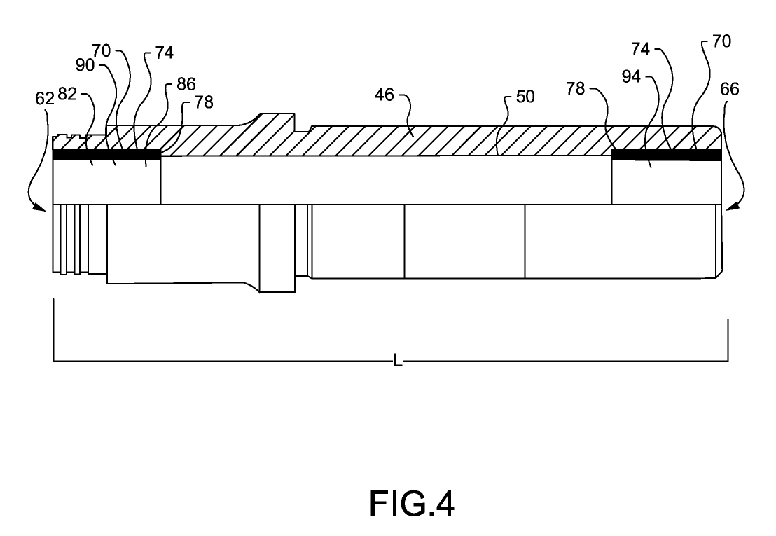

As described, the valve 22 and valve guide 46 may be in close proximity, or contact, and in relative motion. To decrease part wear, a form of friction-reduction may be employed at the interface between the valve 22 and the valve guide 46. To this end, a bearing material 70 may be used, as shown in FIG. 4. Further, the bearing material 70 may be a self-lubricating bearing material 74. The self-lubricating bearing material 74 may be any number of materials with self-lubricating properties including, but not limited to, ceramics, polymers, metals, alloys, sintered graphite bronze, other composites, deva.bm®, Graphalloy® or Glycodur®.

In one embodiment, a bushing 78 is provided, as also shown in FIG. 4. The bearing material 70 may be included in the bushing 78, or may be attached to the bushing 78 by any number of means. Further, the bushing 78 may be steel-backed. The bushing 78 may also include a smaller inner diameter than that of the valve guide 46.

As the valve 22 may experience valve cocking, as described above, the only contact, or only significant contact, between the valve 22 and the valve guide 46 or inner bore 50 may occur at the first end 62, the second end 66 or the first and second ends 62, 66. Accordingly, the bearing material 70 may only need to be applied at one or both of the first and second ends 62, 66 to ensure proper lubrication between the valve 22 and the valve guide 46 or inner bore 50 during operation.

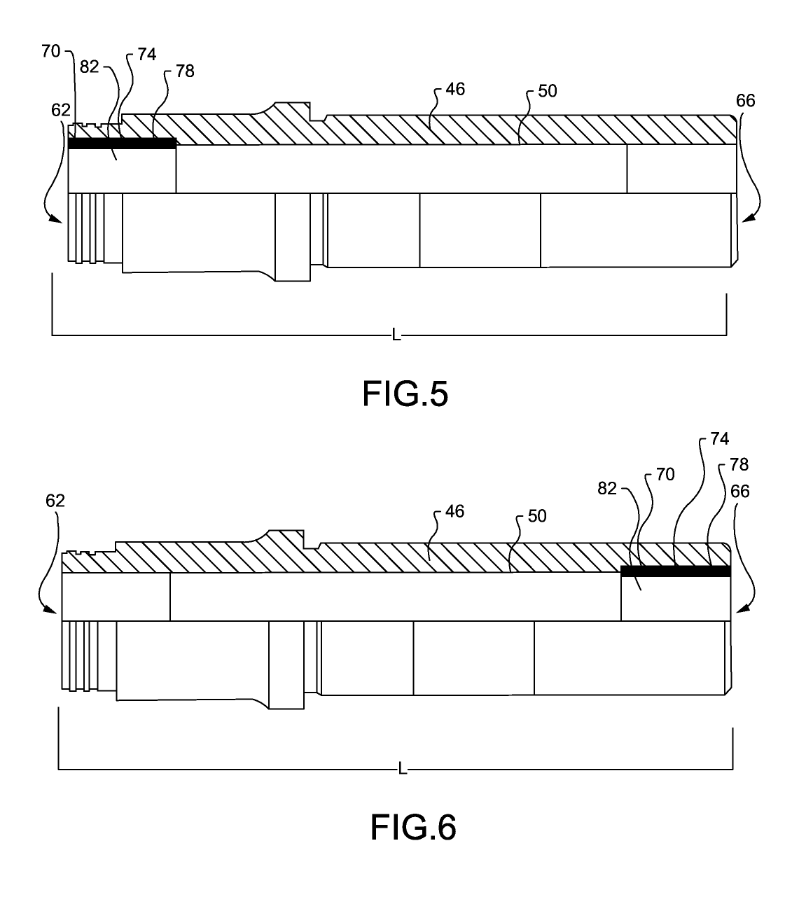

To accommodate such requirements, the bearing material 70 may be employed in the bushing 78, as shown in FIG. 4, and the bushing 78 may be inserted and housed in a mounting structure 82, as shown in FIG. 5. The mounting structure 82 may be located in the valve guide 46, and may support and mount the bushing 78 using commonly-known means in the art including, but not limited to, interference fits, adhesives, welding, friction fits or other means. The mounting structure 82 may be a depression 86 formed in the valve guide 46 or inner bore 50. Per the above-mentioned applications of bearing material 70, a first mounting structure 90 may be located at the first end 62, and a second mounting structure 94 may be located at the second end 66. Each mounting structure 90, 94 may house and support one or more bushings 78. As the one or more bushings 78 may include a bearing material 70, this arrangement allows the areas where all, or a large degree of, contact between the valve 22 and the valve guide 46 or inner bore 50 occurs to be sufficiently covered with bearing material 70, because of valve cocking.

In another embodiment, as shown in FIG. 6, only the first end 62 includes a mounting structure 82, while the second end 66 does not. Such an embodiment would be useful to reduce friction between the valve 22 and the first end 62 when a bushing 78, including the bearing material 70 or self-sealing bearing material 74, is mounted to the mounting structure 82.

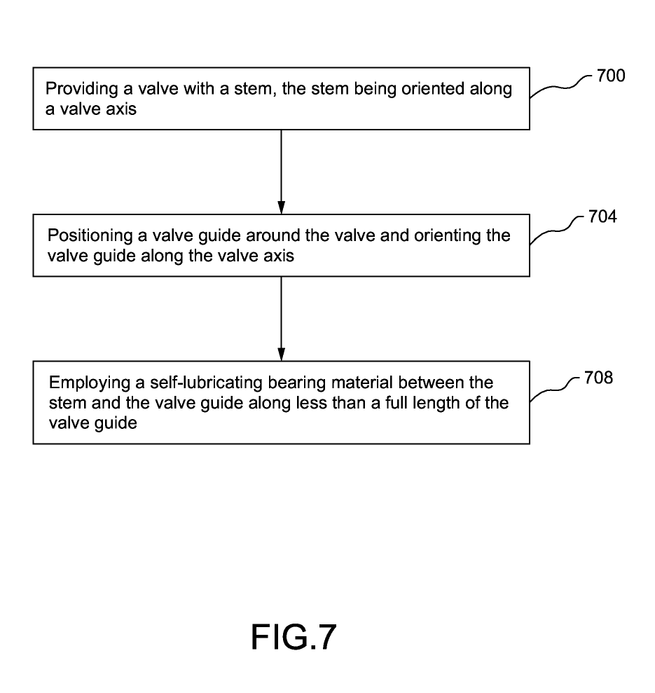

In a further embodiment, as shown in FIG. 7, only the second end 66 includes a mounting structure 82, while the first end 62 does not. Such an embodiment would be useful to reduce friction between the valve 22 and the second end 66 when a bushing 78, including the bearing material 70 or self-sealing bearing material 74, is mounted to the mounting structure 82. While FIGS. 5-7 teach one or two mounting structures 82, it can be understood that employing more than two, each mounting one or more bushings 78, is within the scope of this disclosure. Although not shown, the bearing material 70 may also be directly affixed to the inner bore 50 or the valve guide 46 at the first end 62, the second end 66 or the first and second ends 62, 66.

In each of the aforementioned embodiments, the bearing material 70 may be employed between the stem 26 and the valve guide 46 along less than a full length L of the valve guide 46. This arrangement is advantageous, as will now be explained.

Using a self-lubricating bearing material 74 presents numerous benefits. Rather than relying on lubricating oil entering the valve guide 46 to lubricate the relatively moving parts, the lubricating oil can be largely prevented from entering the valve 46 guide using the seal 58, which may be located at the first end 62. The seal 58, as a zero-leakage seal, could also completely block any oil from entering the valve guide 46. Preventing, or reducing, oil from entering the valve guide 46 reduces oil consumption from oil combustion or vaporization. This improves emissions, oil costs and engine performance. Further, the oil may not lubricate all necessary parts of the valve 22 or valve guide 46 because of clogging, viscosity or oil combustion issues.

In addition to the aforementioned benefits associated with a self-lubricating bearing material 74, the arrangement taught by the present disclosure offers further advantages. Bearing materials 70, and self-lubricating bearing materials 74, have significant costs. For larger engines, this cost is further magnified because of larger engine components. Employing the self-lubricating bearing material 74 between the stem 26 and the valve guide 46 along less than a full length L of the valve guide 46 may allow sufficient lubrication with reduced amounts of self-lubricating bearing material 74. This may be due to valve-cocking, and reduced or minimal contact between the valve 22 and the valve guide 46 or inner bore 50 at certain locations, particularly between the first and second ends 62, 66. Additionally, if the self-lubricating bearing material 74 requires replacement, replacing one or two bushings 78 may be less expensive than replacing such material over the full length L of the valve guide 22.

Moreover, according to the present disclosure, as the valve guide 46 may not itself make contact with the valve 22 during operation, the valve guide 46 may be constructed of a more economical material. Such a valve guide 46 may be designed only to mount the one or more bushings 78, rather than directly support and lubricate the valve 22, freeing the valve guide 46 of such design and material constraints.

The present disclosure not only sets forth a valve system, but a method of reducing friction in a valve system as well. For example, a method of reducing friction between a valve and valve guide in operation can be understood by referencing the flowchart in FIG. 7. The method may comprise providing a valve with a stem, the stem being oriented along a valve axis, as shown in step 700. Further, the method may include positioning a valve guide around the valve and orienting the valve guide along the valve axis, as shown in step 704. Additionally, the method may include employing a self-lubricating bearing material between the stem and the valve guide along less than a full length of the valve guide, as shown in step 708.

### INDUSTRIAL APPLICABILITY

In operation, the present disclosure sets forth a valve system which can find industrial applicability in a variety of settings. For example, the disclosure may be advantageously employed in the efficient operation of internal combustion engines, or in turbocharger waste gates.

Such engines may be provided on many different machines such as, but not limited to, locomotives and earth-moving machines. More specifically, the valve system may employ a bearing material between a stem and a valve guide along less than a full length of the valve guide. The bearing material may be self-lubricating, and the use of such a material allows sufficient lubrication while reducing, or eliminating, oil entering the valve guide using a seal. Preventing, or reducing, oil from entering the valve guide reduces oil consumption from oil combustion or vaporization. This improves emissions, oil costs and engine performance. Further, the oil may not lubricate all necessary parts of the valve or valve guide because of clogging, viscosity or oil combustion issues.

In addition, bearing materials, and self-lubricating bearing materials, have significant costs. For larger engines, this cost is further magnified because of larger engine components. Employing the self-lubricating bearing material between the stem and the valve guide along less than a full length of the valve guide may allow sufficient lubrication with reduced amounts of self-lubricating bearing material. This may be due to valve-cocking, and reduced or minimal contact between the valve and the valve guide at certain locations, particularly between first and second ends. Additionally, if the self-lubricating bearing material requires replacement, replacing one or two bushings may be less expensive than replacing such material over the full length of the valve guide.

Moreover, according to the present disclosure, as the valve guide may not itself make contact with the valve during operation, the valve guide may be constructed of a more economical material. Such a valve guide may be designed only to mount the one or more bushings, rather than directly support and lubricate the valve, freeing the valve guide of such design and material constraints.

The disclosed valve system may be original equipment on new internal combustion engines, or added as a retrofit to existing internal combustion engines.

What is claimed is:

1. A valve system, comprising:
a valve including a stem, the stem being oriented along a valve axis; and
a valve guide disposed around the valve and oriented along the valve axis, wherein a bearing material is employed between the stem and the valve guide along less than a full length of the valve guide.

2. The valve system of claim 1, wherein the bearing material is self-lubricating and included in a bushing, the bushing being attached to a mounting structure in the valve guide.

3. The valve system of claim 2, wherein the bushing is a steel-backed bushing.

4. The valve system of claim 2, wherein the mounting structure is a depression.

5. The valve system of claim 2, wherein the mounting structure is located at a first end and the bushing is located at the first end.

6. The valve system of claim 2, wherein the mounting structure is located at a second end and the bushing is located at the second end.

7. The valve system of claim 2, wherein the valve guide includes a first mounting structure at a first end and a first bushing at the first end, and a second mounting structure at a second end and a second bushing at the second end.

8. The valve system of claim 1, wherein the self-lubricating bearing material is affixed directly to the valve guide.

9. The valve system of claim 1, further including a seal at a first end.

10. The valve system of claim 9, wherein the seal is a zero leakage seal.

11. The valve system of claim 2, wherein the self-lubricating bearing material is deva.bm®.

12. The valve system of claim 2, wherein the self-lubricating bearing material is Glycodur®.

13. An internal combustion engine, comprising:
an engine block;
a cylinder provided in the engine block;
a valve system including a valve operatively associated with the cylinder, the valve including a stem, the stem being oriented along a valve axis; and
a valve guide disposed around the valve and oriented along the valve axis, wherein a bearing material is employed between the stem and the valve guide along less than a full length of the valve guide.

14. The internal combustion engine of claim 13, wherein the bearing material is self-lubricating and included in a bushing, the bushing being attached to a mounting structure in the valve guide.

15. The internal combustion engine of claim 14, wherein the bushing is a steel-backed bushing.

16. The internal combustion engine of claim 14, wherein the mounting structure is located at a first end and the bushing is located at the first end.

17. The internal combustion engine of claim 14, wherein the mounting structure is located at a second end and the bushing is located at the second end.

18. The internal combustion engine of claim 14, wherein the valve guide includes a first mounting structure at a first end and a first bushing at the first end, and a second mounting structure at a second end and a second bushing at the second end.

19. The internal combustion engine of claim 13, further including a seal at a first end.

20. A method of reducing friction between a valve and valve guide, comprising:
providing the valve with a stem, the stem being oriented along a valve axis;
positioning a valve guide around the valve and orienting the valve guide along the valve axis; and
employing a self-lubricating bearing material between the stem and the valve guide along less than a full length of the valve guide.
